(19) United States
(12) Patent Application Publication
(10) Pub. No.: US 2007/0081924 A1
(43) Pub. Date: Apr. 12, 2007

(54) Scrubbing "ionized" rainstorm tunnel (S.I.R.T)

(76) Inventors: Ian Frederick Hood, Toronto (CA); Steven Dennis Poulos, Toronto (CA)

Correspondence Address: HOOD, IAN and POULOS, STEVE, Suite 300, 645 King St. W., TORONTO, ON, M5V 1M5, CA

(21) Appl. No.: 11/247,090

(22) Filed: Oct. 12, 2005

(51) Int. Cl. B01D 53/34; B01D 50/00; B32B 27/02

(52) U.S. Cl. 422/168

(57) ABSTRACT

Method and apparatus for Scrubbing exhaust streams to approach Zero Emissions with utility in Coal Fired Electricity Generation. The Scrubbing “Ionized” Rainstorm Tunnel (S.I.R.T.) a.k.a. Natural State Hydrologic Cycle Emulator comprises a tunnel that sprays exhaust streams with “ionized” water, cost effectively scrubbing toxic constituents mimicking the atmospheric and hydrologic cycle. Various tunnel configurations greatly increase dwell times beyond that of other methods to any chosen scrubbing agent allowing for more complete absorption of all toxic emissions i.e. sulfates, nitrates, heavy metals and volatile organic compounds produced by combustion of coal or other dirty fuels. The design incorporates advantageous removal points for further micro and nano effluent treatment and simplified sequestration of Carbon Dioxide if desired. A Nozzle Automated Positioning and Retrieval System (NAPRS) allows for continuous operation of boilers or other processes as failed spray nozzle heads can be serviced outside the tunnel without down time.

### RELATED APPLICATIONS

This application claims priority to the following U.S. Provisional Application No. 60/615,685, filed Oct. 5, 2004, and is incorporated herein by reference. Inventors: Hood,Ian F.; (Toronto,Canada); Poulos,Steven D.; (Toronto,Canada)

### BACKGROUND OF THE INVENTION

Coal is the most abundant and easily recovered form of energy source currently extant for all of the world's countries irrespective of their level of technological advancement and so is employed for power generation wherever it is feasible. Coal powered electricity generation emits huge quantities of CO2 into the atmosphere and so coal is one of the biggest contributors to greenhouse gas emissions and therefore global warming. Coal burning also emits acid rain components (NOx & SOx) and toxic heavy metals (Hg & U). The present invention simplifies the process of recovering and/or sequestering of all toxic and greenhouse gas emissions far more inexpensively than all other prior apparatus and methods by emulating the cleansing attributes of the hydrologic cycle.

An additional benefit of the present method is the ease of recovery of waste heat that is usually vented to the atmosphere, for district heating or local industrial processes furthering efficiency of the Rainstorm Tunnel at eliminating greenhouse gas emissions.

### INVENTION SUMMARY

The chief utility of the invention its unique design that allows for:
1. dramatically reduced construction and operating costs over other methods of exhaust gas scrubbing
2. ease of maintenance
3. ease of scalability
4. penultimate scrubbing control device efficiency

The invention can consist of either a single tunnel or have multiple tunnels run in series or parallel and each to any length depending on the volume of the effluent and the configuration of the power plant/effluent generating process and/or its site. The chief efficiency of the invention comes from the use of “ionized” water in a tunnel with spray nozzles, but any scrubbing agent extant can be used depending on the constituent contamination of the effluent gas and how close to ‘zero emission’ it is desired that any specific installation of “The Rainstorm Tunnel” process needs to be.

The Key to the invention is its emulation and compression of the Hydrologic Cycle in its operation. In nature the Hydrologic Cycle uses chiefly sunlight, gravity, electrical discharges (lightning) and precipitation to cleanse the air. The vortices created due to wind forces of a storm combined with the resident time of particulates within moisture-laden environments and their exposure to sunlight add to the cleansing and purifying of pollutant air. The Rainstorm Tunnel compresses the effects of the larger natural environment into an overall linear controlled environment that emulates the Hydrologic Cycle to carefully control all variables for maximum efficiency. The device scrubs the effluent with a pressurized rain/spray that absorbs the toxic constituents using water that has been de-agglomerized and polarized (“ionized”) through processes known to those skilled in the art. De-agglomerized and polarized (“ionized”) water readily absorbs and dissolves soluble compounds at a much higher rate than normal. The addition of ozone and sunlight to the Rainstorm Tunnel creates photochemical smog that can then be cleansed by the rain/spray. Residence time in the rain/spray is the increased by orders of magnitude over all other prior art contributing to the efficiency of the Rainstorm tunnel in removing toxic cleansing effluent from exhaust streams. The rain/spray is collected by gravity in the bottom of the tunnel and/or is pumped to a settling tank to precipitate the fly ash and the resultant effluent liquor is then received in an electro-coagulation tank and /or passed through a membrane to collect the remaining dissolved toxic metals and oxides of sulfur and nitrogen. The laminar flow effect in the tunnel sees some gas moving by spray force and by tunnel shape in helical motion along the outer edges of the tunnel, while gases in the center are seen as traveling at different velocities and targeted to be spray-blown into the ponding sections at the base of the tunnel to be further mixed with the outer streams. Additional vortices created are the effects of the central flow folding into the outer flows at approximately the inner most edge of the helical fence/rib version or varying the orientation of the spray nozzles along the length of the tunnel. The chaotic or non-chaotic result of gas volume factors ratio to helical wavelength and amplitude factors are calculated depending on the volume and constituency of the effluent stream using present day understandings of vortex design, absorption factors due to gas pressure, distance and time traveled within control device, material surface texture and area, and variables relating to the introduced agent properties. It is the intention of the Rainstorm Tunnel that a degree of the momentum of the swirling action within a helical vortex is maintained to provide a continuous and maximal surface absorption, velocity and residence time as in nature as apposed to other methods of screening, filtering, catalytic chemical reductions, combustion modifications, and precipitating that require significantly more process energy and often require complete retooling of existing power plants. The Rainstorm Tunnel can eliminate or reduce the size of dust collectors, the need for coal preparation prior to burning, lime input for SO2 scrubbing, bag-houses, electrostatic precipitators, complex multiple grid piping systems, pure oxygen and low nitrogen combustors and the attendant maintenance problems and costs. The Rainstorm Tunnel using custom designed spray nozzles to create optimal droplet sizes and GWPT's proprietary Nozzle Auto-Positioning & Retrieval System (NAPRS) for ease of maintenance can accommodate varying coal fired plant layouts and effluent stream volumes and constituents with ease and flexibility. Virtually any process known for scrubbing exhaust can be attached to the rain tunnel for final polishing so that the released gas stream to the atmosphere can be totally benign to the environment. It is the intention of the Rainstorm Tunnel to reduce or eliminate the need and therefore the cost of implementation for the most of these processes. Because of this flexibility and simplicity, due to its artful design, the Rainstorm Tunnel can also be segmented and portable to a degree impossible with other systems of screening and filtering and settling.

### BRIEF DESCRIPTION OF THE DRAWINGS

FIG. 1 shows a plan view of the Rain Tunnel attached to an existing coal fired power plant.

FIG. 2 shows a elevation of the Rain tunnel attached to an existing coal fired power plant.

FIG. 3 shows an oblique view of a helically fenced version of the Rain Tunnel

FIGS. 4a to 4b1 show a cross-sectional detail of various versions of the Rain Tunnel with piping outside the tunnel
FIG. 4a fixed nozzle version that has maintenance access from the interior of the tunnel
FIG. 4a1 fixed nozzle version detail
FIG. 4b Nozzle Auto-Positioning and Retrieval System (NAPRS) cross section
FIG. 4b1 Nozzle Auto-Positioning and Retrieval System (NAPRS) detail

FIG. 5 shows a wall detail for piping embedded in the tunnel

FIG. 6 Rain Tunnel Isometric

### DETAILED DESCRIPTION OF THE INVENTION

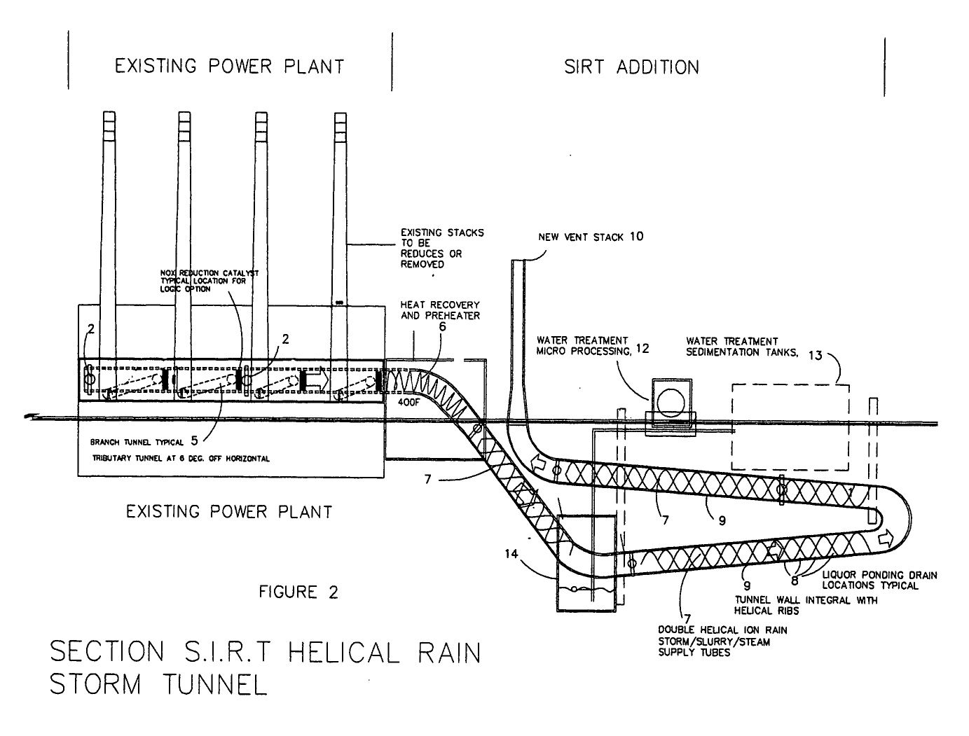

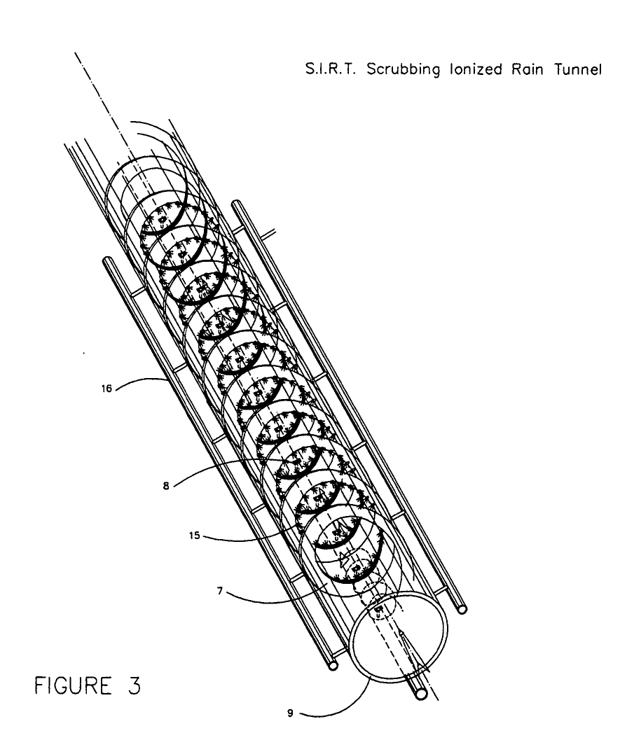

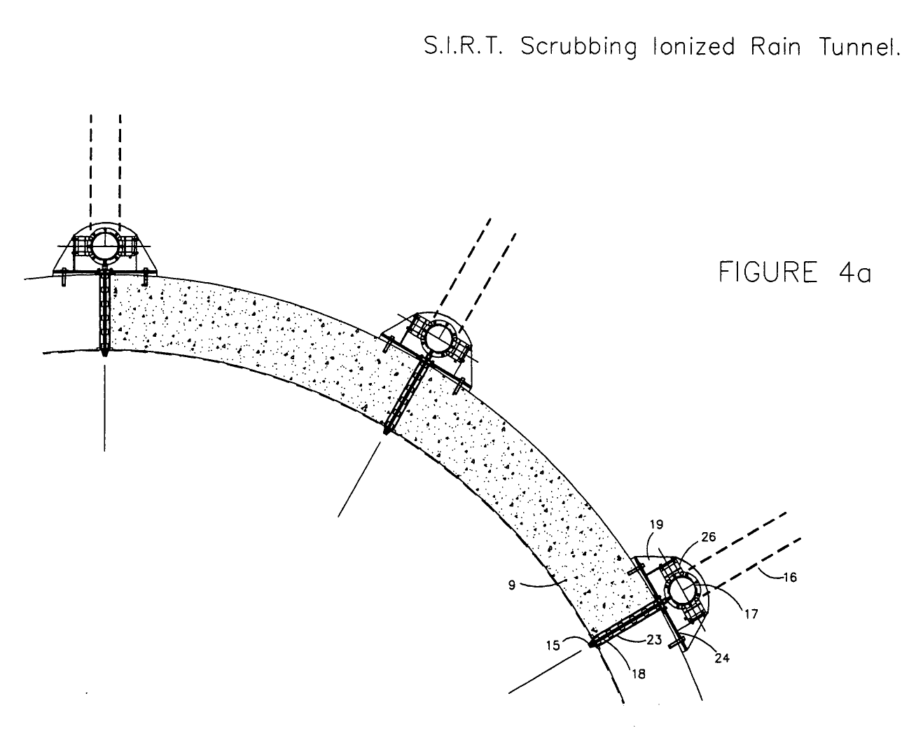

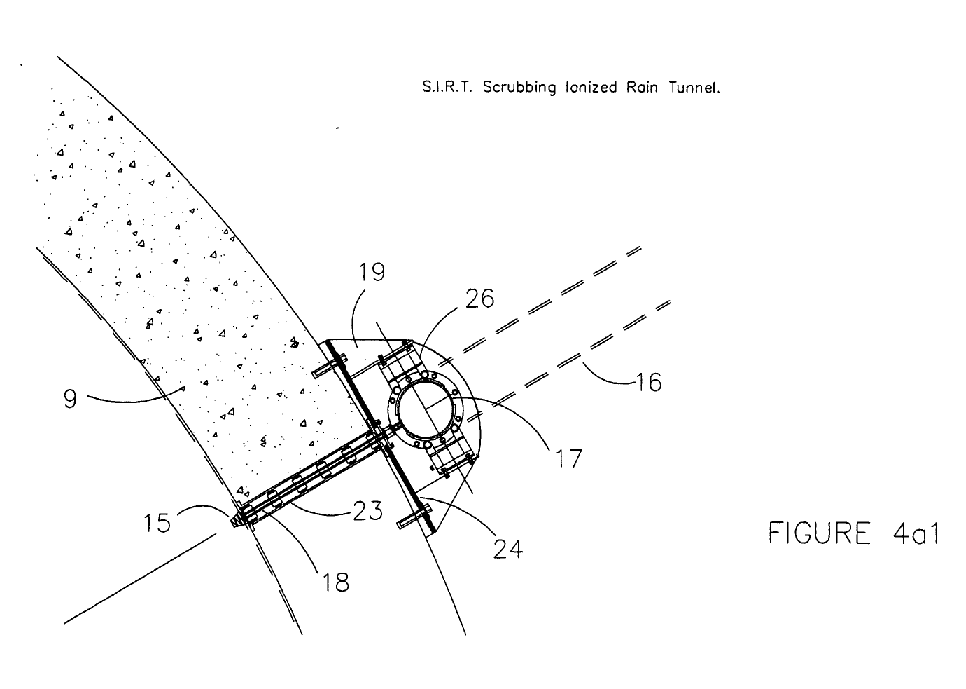

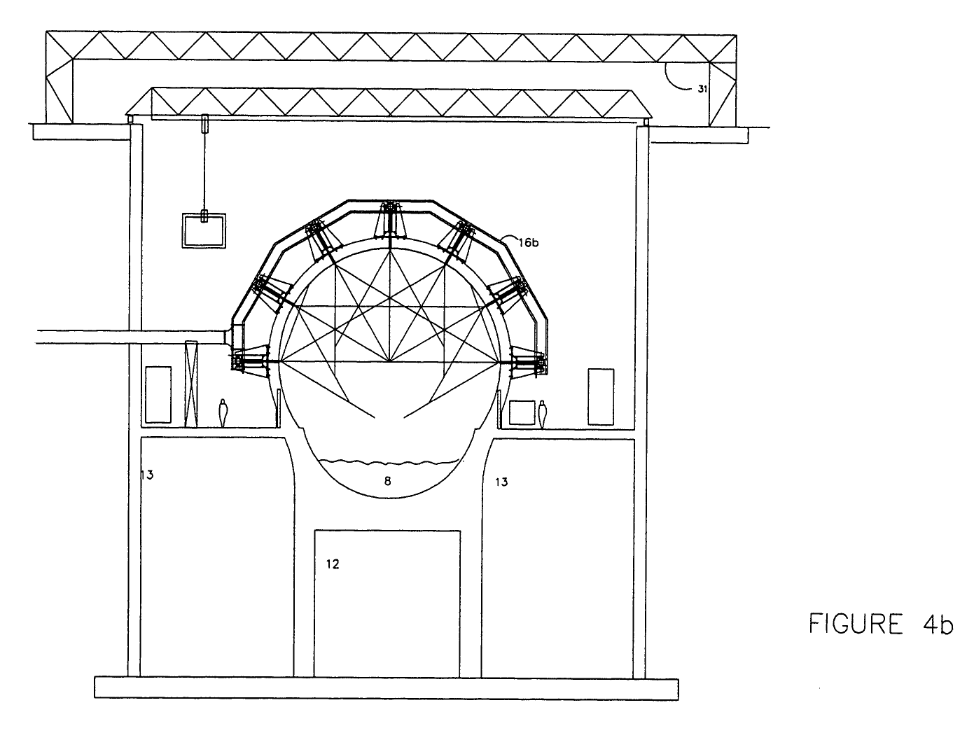

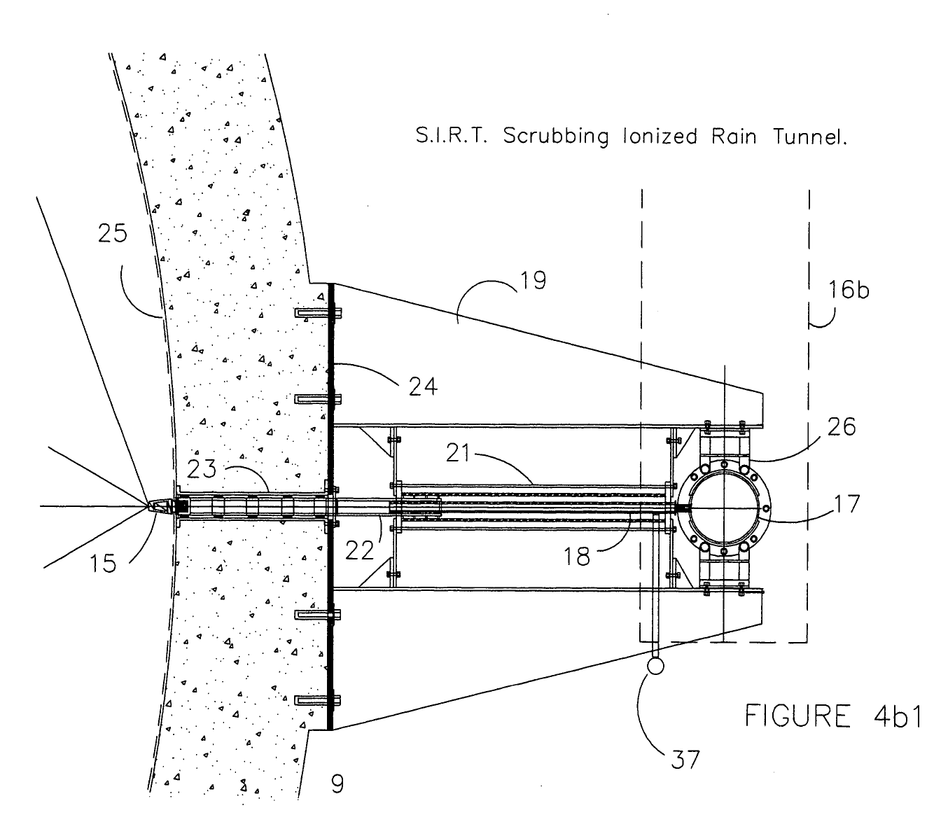

In accordance with the present invention briefly described herein FIG. 2 shows a greatly simplified system for removing all toxic constituents of any gaseous effluent stream at any temperature with or without heat exchangers (6) via spray nozzles (15), using “ionized” water, steam or slurry spray introduced artfully into a sloped or horizontal tunnel to create a vortex in the exhaust stream thereby increasing its dwell time in the spray. The helical interior shaped version (FIG. 3) creates ideal conditions to maximize the spray contact time with the exhaust stream. The single, double or triple helical fence/rib (7) embodied in the present invention minimizes construction complexity and cost as the fence/rib integrally strengthens the Rainstorm Tunnel's structure. FIG. 3 shown represents a single helix, high fence & high frequency configuration. An actual tunnel variation may incorporate as little as one or a multiple of helical grooves/fences along the tunnel surface made of stainless steel with welded on rebar or other high strength/ high temperature resistant concrete/plastic/composite material to become integral with a formed concrete/plastic/composite tunnel and drains therein to act as ponding and collection devices. A Rainstorm Tunnel version having only spray nozzles (FIGS. 4a, 4a1, 4b, 4b1) will impart the beneficial vortex, centrifugal and ponding effects without the impediment of a fence by having the piping on the outer periphery of the walls of the tunnel with some of the nozzle heads extensible into the very centre of the tunnel to penetrate the central vortex created in the tunnel using the Nozzle Auto-Positioning & Retrieval System (NAPRS). FIGS. 4b & 4b1 illustrate a tunnel section and enlargement of the Nozzle Auto-Positioning & Retrieval System (NAPRS). Illustrated in FIG. 4b1 is the detail of the installed aspect of the NAPRS hydraulic spray-head moving device. “Ionized” water enters through main pipes (16b) which connect to the distribution pipes (17) which are held to the exterior of the SIRT by clamps (26) bolted to brackets (19) welded to a plate (24) which is bolted to the SIRT wall (9). The distribution pipes (17) feed pressurized “ionized” water to the connected feeder pipes (18) through the telescoping hydraulically operated feeder pipe extension (22) that penetrates the SIRT wall(9) and its liner(25) moving through a sleeve (23) to position the spray head (15) The hydraulic fluid is fed by hoses(37) and the moving feeder pie extension(22) and the feeder pipe(18) are held to the brackets by bolts (21).

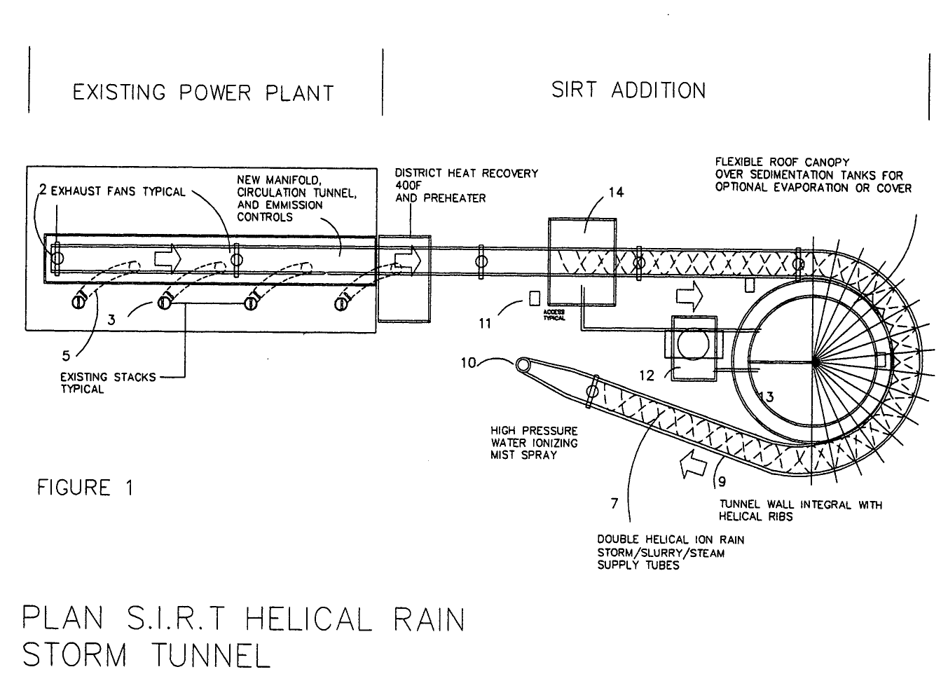

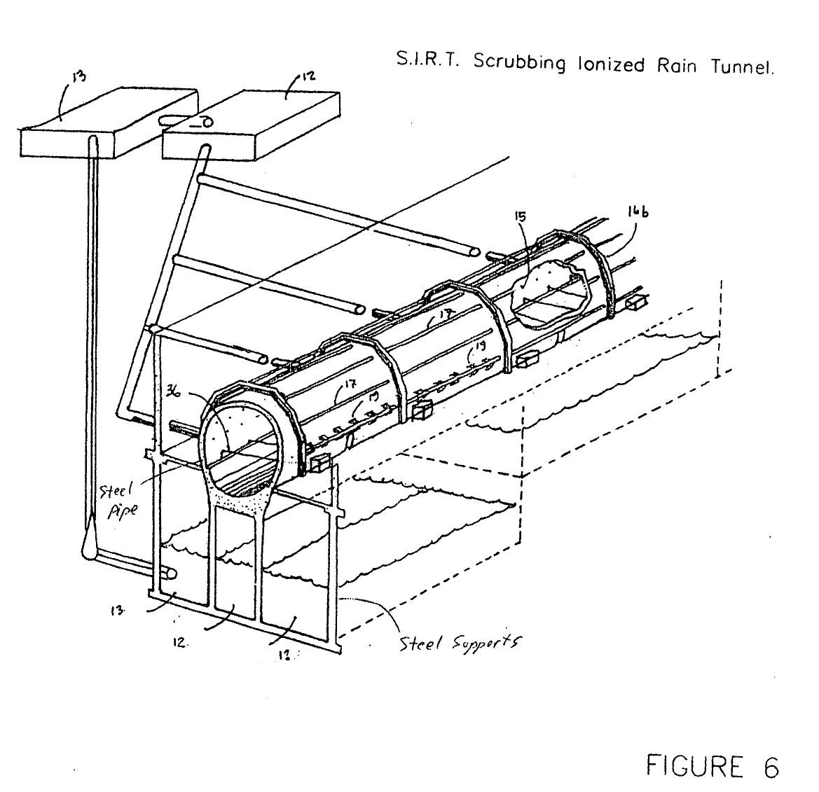

Helical fencing (FIG. 3) for certain applications may be constructed from identical modules arranged along a given calculated path for each particular application, and may move through various frequencies within the path length. The high pressure spray nozzles (15) that are arrayed along the fence/rib or embedded in the walls of the tunnel can be angled to impart radial and axial momentum to the effluent gas, and may be positioned alternatively in any location along the tunnel wall being fed from supply pipes running longitudinally or spirally inside, outside or embedded in the tunnel wall. This advantageously results in a decrease in the necessary size and power of the induced draft fans as the gas will mix and flow naturally by the vortex created by the fence/rib and the spray and causing a natural centrifuge effect. Illustrated is the advantageous embodiment of the invention wherein the axial cross sectional FIG. 1 shows induced draft fans (2) moving exhaust gas into a downward sloped tunnel (7), in which heat exchangers (6) can be installed to create process steam for steam stripping of volatile gases and sulfurs and/or heat removal for district heating/industry plus the necessary preheat of the rain/spray and reheating of the effluent gas discharged to the atmosphere if desired. The Rainstorm Tunnel can also enter the ground to take advantage of ground source cooling. Subsequently the new stack dimensions are dramatically reduced and therefore have less impact on the local esthetics. It is within the scope and intention of the Rain Tunnel to purify gases to medical or food grade quality to produce a revenue stream from the said purified gases for tunnel operators. The initial parts of the tunnel can contain, in the case of a coal fired generating station, a series of helically shaped or standard heat exchanger pipes (6) to preheat the slurry or “ionized” water and/or create steam to be used in steam stripping volatiles from the effluent gas if desired, the configuration of which will depend on the constituent effluent gas. From the initial stage the tunnel proceeds to a to a chamber (14) in which the initial highly concentrated liquor is collected to be pumped to sedimentation tanks (13) and then to electro-coagulation processing (12 ) and/or membranes and/or ozonation and/or any other existing prior art process necessary to purify the liquor and its off-gas. From the chamber the tunnel proceeds upward and can contain one and as many as three helical fence/ribs (7) positioned spirally along the tunnel wall and such ribs have advantageously spaced spray nozzles (15) along its interior edge to maximize exposure to and dwell time of the exhaust gas in the “ionized” water or slurry spray and/or steam. Alternatively the nozzles themselves (15) embedded in the tunnel wall can impart a cyclonic effect by their aspect with some of the nozzle heads extensible into the very centre of the tunnel to penetrate the central vortex created in the tunnel. Alternatively the Nozzle Auto-Positioning & Retrieval System (NAPRS)(4b, 4b1), which the nozzles(15) can be mounted on, can move the feeder pipes(18) telescoping them through the tunnel wall (9) to either hydraulically or manually move them for ease of maintenance and safety of the workers as the workers would never have to enter the tunnel nor the tunnel shutdown for maintenance (FIG. 6). The resultant is a controlled linear cyclonic rainstorm. Parameters will include a sound wave analysis to avoid potential reverberation resulting in sound and if deemed necessary reverse wave sound deadening equipment installed (noise canceling). The ribs can also act as heat exchangers if so desired by embedding piping within them or eventuating them as pipes illustrated in FIG. 3. The feeder pipes(18) for the spray nozzles (15) are modularized and sectioned off for ease of maintenance. The helical fence/rib in the sloped or horizontal tunnel (9) creates multiple natural collection points/pools as temporary storage of the liquor in the tunnel which then can be siphoned to the main drains (8) and once the concentration of contaminants in the runoff liquor has reached the desired level then the liquor can be piped away for further processing. The resultant purified exhaust is released to the atmosphere via the vent stack (10).

Note:

In the helical rib design (FIG. 3) each drain (8) will contain diminishing concentrations of contaminants and/or completely different contaminants both in relation to the increasing distance along the tunnel from the source of the coal smoke and what is being sprayed into the tunnel at that particular point, as both can vary to the constituents of the effluent, which would allow differing levels of further processing as the liquor at every drain (8) would not need every step of the purification process (as at each collection point the concentration and/or makeup of the runoff liquor varies and this can create diminishing returns for effort expended to cleanse the liquor). The last few drains (8) can simply have their thinly contaminated liquor returned to the first few spray nozzles allowing for much more efficient reuse of the cleansing spray as it does not have to be processed to complete purity before being reused. Only liquor that has the highest concentration of contaminant needs to be piped away for further processing by electro-coagulation, electro flocculation, precipitate settling, aeration or sequestration depending on the constituent toxicity.

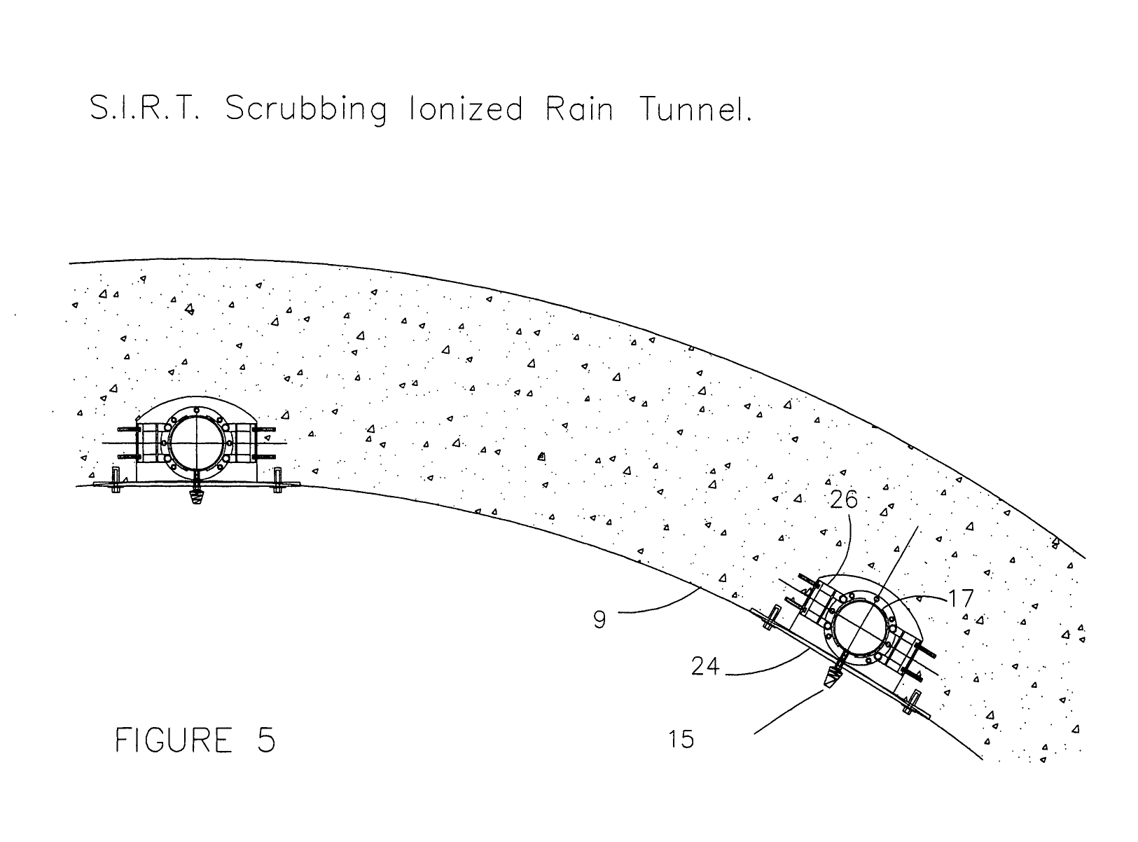

In simplified versions of the tunnel for effluent streams that are not highly contaminated or for small volumes of effluent the helical ribs can be eliminated and the distribution pipe itself (16,16b) can either be shaped in a helical or straight-line configuration. In applications where a very high pressure of “ionized” rain or scrubbing slurry mixture is needed as in a coal fired exhaust stream, the feeder pipe can be mounted inside the tunnel walls with only the spray heads exposed to the effluent in a helical or straight-line fashion or attached to the inside of the tunnel walls (FIG. 5), such design placement and materials used dependant on the toxicity and corrosiveness of the effluent. In the case of a coal fired power plant the fly ash would be settled out in a pond, tank or optimally in the bottom of the tunnel(12) and the resultant liquor further processed via membranes and electro coagulation(13) to remove the Sulfates and Nitrates that are in the exhaust streams of coal fired boilers, smelters, incinerators and other high emission processes. Other technologies for Nox and Sox reduction in the effluent can take place before, during or after the Rainstorm Tunnel but it is the intention of the tunnel to reduce or eliminate the need for those technologies. Should the process be taken to its final and penultimate stage the carbon dioxide in the exhaust gas from the coal fired power plant or any other effluent stream, could be sprayed with a calcium and enzyme mixture for further sequestration as carbonate or compressed for industrial uses. The tunnel maintains a closed loop and processes the resultant liquor until the water is pure enough to be reused in the tunnel. Dwell time and mixing in the tunnel and therefore contact time to the spray is varied to the toxicity, temperature and density of the effluent gas by increasing or decreasing one of the following variables including but not limited to:
a) The fence / rib height
b) The slope of the tunnel
c) The length of the tunnel
d) The diameter of the tunnel
e) The coil tightness (frequency) of the rib along the tunnel wall
f) The density of the spray nozzles
g) The orientation of the spray nozzles
h) The pressure of the spray
i) The number of fences coiled about one another on the tunnel wall
j) The constituents of the spray
k) The size of the spray droplets
l) Surface texture on fence/ribs and tunnel wall
m) Periodically reversing or changing the aspects of the fence/rib coil on the tunnel wall
n) Eliminating the fence/rib
o) Helical arrangement of the spray nozzles/pipe
p) Straight-line arrangement of the spray nozzles/pipe
q) Materials and design of the spray nozzles/pipe
r) Positioning of the spray nozzles/pipe in the vortex
s) Embedding the pipe in the tunnel wall
t) Attaching the pipe to the tunnel wall
u) Materials and design of the tunnel
v) Sealing the tunnel and batching the effluent to increase dwell time
w) Running multiple tunnels in series or parallel
x) Any combination of the above

It is understood that various other embodiments and modifications in the practice of the invention will be apparent to, and can be readily made by, those skilled in the art without departing from the scope and spirit of the invention described above. Accordingly, it is not intended that the scope of the claims appended hereto be limited to the exact description set forth above, but rather that the claims be construed as encompassing all of the features of patentable novelty which reside in the present invention, including all the features and embodiments which would be treated as equivalents thereof by those skilled in the art to which the invention pertains. The “ionized” water spray main supply pipes may be introduced along the tunnel length (16 & 16b) in any number and have branched piping into the tunnel at various intervals to effect the desired the result contained herein.

1) A Rainstorm style of cleansing apparatus for purifying effluent streams of combustion gases comprising:
a first exhaust pipe having an inlet for introducing effluent gases being purified and an outlet for discharging purified gases to the atmosphere or sequestration with artfully designed spray nozzles and piping to introduce an effluent scrubbing spray;
a first heat exchanger consisting of at least two separate systems of piping the first for removing heat to reheat the purified exhaust stream for dispersion to the atmosphere if sequestration is not desired and the second for preheating the purifying spray before introduction into the tunnel through first main supply pipes then distribution pipes and finally feeder pipes with nozzles at their terminus, such piping artfully designed to have either a spiral aspect or straight line configuration within the tunnel and/or embedded in fences/vortex generators depending on the specific application of The Rainstorm Tunnel;
tanks and/or hoppers with valves, pumps and metering equipment, whose design is known to those with ordinary skill in the art, to supply said purifying substances;
connected to the tanks/hoppers a plurality of main supply pipes, either in series or parallel, that run through the second set of heat exchangers;
connected to the main supply pipes, distribution pipes, either in series or parallel, connected in such a way to supply said purifying substances to the feeder pipes;
feeder pipes, connected to the said distribution pipes, extending through the tunnel wall, for ease of maintenance and safety of the workers;
high intensity lighting advantageously situated in the tunnel for worker maintenance and smog removal when needed;
a plurality of nozzles located at the terminal of said feeder pipes to spray purifying substances into the exhaust stream, such substances sprayed and/or artful location and design of the nozzles and their aspect dependant on the volume, temperature and constituents of the effluent gas and it's suspended particulates as all will vary from one specific application to the next;
pumps and valves whose design is known to those with ordinary skill in the art, located before, after or along the main supply pipes to move and pressurize the said purifying substances for delivery to the distribution pipes and feeder pipes; a first sump drain or plurality of sump drains located in the bottom of the tunnel to drain said purifying substances now contaminated with effluent from the tunnel;
connected to the sump drains a pipe or plurality of pipes with metering equipment, valves and pumps, whose design is known to those with ordinary skill in the art, for carrying said contaminated purifying substances away for further processing, such processing to be dependant on the constituent contaminants and generally known to those with ordinary skill in the art;
a plurality of vortex generators and/or fences and/or piping artfully located within the tunnel to create a vortex within the exhaust stream thereby increasing the dwell time and the path length of the effluent increasing the efficiency of the scrubbing spray.

2) A Rainstorm Tunnel as defined in claim 1 with particular utility for mitigating or completely eliminating toxic and greenhouse gas releases from coal fired electricity generation comprising;
a first exhaust pipe having an inlet for introducing coal smoke with a blowback damper valve to suppress blowback during the startup phase of the coal furnace, such damper design known to those with ordinary skill in the art, and outlets for a) discharging the detoxified exhaust stream to the atmosphere and/or b) an outlet to a chamber/tank for separation and compression of purified carbon dioxide to provide a raw material for further industrial uses and/or c) an outlet to a further Rainstorm Tunnel or tunnels in series or parallel from the first tunnel with all of the same attributes of the first tunnel as described herein, for sequestration of the carbon dioxide by spraying a mixture of enzymes and calcium to create limestone for use as a raw material for further industrial uses and/or d) any combination of said outlets as desired or e) a closed ended tunnel to increase dwell time and to allow for either complete capture and compression of the carbon dioxide or sequestration of the carbon dioxide as limestone;
a first heat exchanger consisting of at least two separate systems of piping the first for removing heat to reheat the purified exhaust stream for dispersion to the atmosphere if sequestration is not desired and the second for preheating the purifying spray before introduction into the tunnel through distribution and feeder pipes, such piping artfully designed to have either a spiral aspect or straight line configuration within the tunnel and/or embedded in fences/vortex generators;
tanks and/or hoppers with valves, pumps and metering equipment, whose design is known to those with ordinary skill in the art, to supply said purifying substances;
connected to the tanks/hoppers main supply pipes, either in series or parallel, that run through the second set of heat exchangers in or on later areas of the tunnel ultimately connected to nozzles to deliver the preheated scrubbing spray into the coal smoke exhaust stream,
distribution pipes as a continuation of the main supply pipes artfully designed mounted either on the outer periphery or embedded in the walls of said first exhaust pipe/tunnel and/or on the fences and/or on the vortex generators and/or the design and location of the pipes themselves artfully located to produce a vortex in the exhaust stream;
a plurality of feeder pipes connected to the said distribution pipes extending through the tunnel wall artfully designed to telescope back and forth through the tunnel wall, either hydraulically or manually in the case of failure of the hydraulics for ease of maintenance and the safety of the workers as the tunnel would never have to be shutdown unless desired or the workers even enter it to change the nozzle heads on the end of the feeder pipes if they became eroded/clogged and/or require modification/upgrading;
a plurality of nozzles located on the terminus of said feeder pipes, to spray purifying substances into the exhaust stream, in the first areas of the tunnel the spray will consist of purified “ionized” water, “ionized” water to consist of de-agglomerated and polarized water whose methods of production are known to those with ordinary skill in the art, to absorb the greatest amount of heavy metal containing fly ash, noxious nitrates, sulfates, hydrogen fluoride and other volatile organic compounds; in later areas of the tunnel series the substances sprayed could consist of slurries of calcium and enzymes to sequester the carbon dioxide as limestone, such variation and combination of sprays dependant on the volume, temperature and constituents of the effluent gas and it's suspended particulates as they vary along the length of the tunnel and whether total sequestration of the resulting carbon dioxide is desired, said nozzles having angles and aspects artfully aimed to produce a both vortices in the coal smoke and to wash the walls/fences/vortex generators within the tunnel;
high intensity lighting advantageously situated in the tunnel for worker maintenance and smog removal when if and when needed;
mechanical, magnetic or electric water “ionizing” apparatus, known to those of ordinary skill in the art, around or within the said main supply pipes to “ionize” the water within them;
a first sump drain or plurality of sump drains located in the first areas of the tunnel at the bottom of the tunnel to drain said “ionized” water, now contaminated with fly ash and heavy metals and other toxic constituents from the coal smoke in the tunnel, artfully designed to drain from differing parts of the tunnel the contaminated “ionized” water which will have varying densities and constituents of contamination the further away they are drained from the tunnel inlet and the source of the coal smoke; for efficient processing to reduce costs and complexity should it be desired in any particular application with utility and art varying to the unique design of, and constituents of the particular coal burned in any one individual coal fired electrical generation plant, as both vary from one plant to the next;
connected to the sump drains in the first areas of the tunnel a pipe or plurality of pipes for carrying said contaminated “ionized” water away to settling tanks/ponds whose design is known to those with ordinary skill in the art, to separate the fly ash from the resulting contaminated “ionized” water;
connected to the settling tanks/ponds a pipe or plurality of pipes to carry away the contaminated “ionized” water for sedimentation and/or electro-coagulation and/or electro-flocculation and/or membrane filtering and/or sand filtering processing to remove the heavy metals, nitrates, sulfates and volatile organic compounds, such processing to be dependant on the constituent contaminants and known to those with ordinary skill in the art;
a plurality of vortex generators and/or fences and/or piping artfully located within the tunnel to create a vortex within the exhaust stream thereby increasing the dwell time and the path length of the effluent increasing the efficiency of the scrubbing rain/spray.

3) Rainstorm Tunnel as described in claim 1 whose purifying substances sprayed consist of water that has been de-agglomerized and polarized (“ionized”) to increase its solubility to effluents in the exhaust stream.

4) A Rainstorm Tunnel as defined in claims 2 and 3 whose purifying substances can be sprayed in combination with ozone.

5) Rainstorm Tunnel as defined in claim 4 whose purifying substances are sprayed in combination with ozone and are exposed to concentrated sunlight piped in by fiber optic means to create photochemical smog within the tunnel so it can be cleansed by the rain/spray.

6) A Rainstorm Tunnel as defined in claim 1 whose purifying substances are sprayed by movable nozzles that telescope through the wall of the tunnel to reduce or eliminate both servicing downtime in the tunnel and exposure of workers to toxins in the tunnel.

7) A Rainstorm Tunnel as defined in claims 1 and 2 segmented and erected on railroad bogies or highway floats, for ease of transport and/or mobility on site for as the coal fired plants the mobile tunnels are associated with become obsolete and are decommissioned the segmented tunnels can be economically moved and reused without losing the capital investment in their construction.

8) A Rainstorm Tunnel as defined in claims 1 and 2 segmented and compartmentalized for ease of replacement of segments or ease of maintenance of segments.

9) A Rainstorm Tunnel as defined in claims 1 and 2 that has functionally attached to it means of electro-flocculation and/or electro-coagulation to cleanse the smog from the “ionized” water and mimic the effects of lightning.
